(19) United States
(12) Patent Application Publication
(10) Pub. No.: US 2025/0114966 A1
(43) Pub. Date: Apr. 10, 2025

(54) METHOD OF MANUFACTURING A FIBERBOARD

(71) Applicant: SWISS KRONO Tec AG, Luzern (CH)

(72) Inventors: Joachim Hasch, Berlin (DE); Roger Braun, WILLISAU LU (CH); Dorin Moisch, Luzern (CH)

(73) Assignee: SWISS KRONO Tec AG, Luzern (CH)

(21) Appl. No.: 18/834,465

(22) PCT Filed: Jan. 17, 2023
(86) PCT No.: PCT/EP2023/050972

§ 371 Date: Jul. 30, 2024

(30) Foreign Application Priority Data
Jan. 31, 2022 (EP) 22154303.6
Aug. 9, 2022 (EP) 22189510.5

(51) Int. Cl. B27N 3/00; B27N 3/04

(52) U.S. Cl. CPC B27N 3/002; B27N 3/04

(57) ABSTRACT

The invention relates to a method for manufacturing a water-resistant fiberboard including lignocellulosic fibers and binders. In order to provide a cost-effective, water-resistant fiberboard, the following steps are provided: providing lignocellulosic fibers, providing the binder, providing an elasticizing additive, applying the binder and the elasticizing additive, forming the fiber cake from the fibers provided with binder and elasticizing additive, pressing the fiber cake in a press while curing of the binder to manufacture a fiberboard, wherein 15 wt. % to 35 wt. % melamine resin, phenolic resin, mixtures and mixed condensates thereof or guanamine resin and 5 wt. % to 20 wt. % urea resin as binders as well as 0.1 wt. % to 7 wt. % of the elasticizing additive, in each case based on the total weight of the fiberboard (atro), are used. The invention further includes a water-resistant fiberboard.

### BACKGROUND OF THE INVENTION

The invention relates to a method of manufacturing a fiberboard. The invention further relates to a fiberboard.

Fiberboards, in particular water-resistant fiberboards, are known from WO 2020/211988 A1, for example. However, these fiberboards have proven to be very expensive due to the high binder content.

### SUMMARY OF THE INVENTION

The object is to provide a water-resistant fiberboard that is cheaper to manufacture.

The object is solved by a method and a fiberboard as disclosed herein.

The method according to the invention for manufacturing a water-resistant fiberboard comprising fibers and binder, comprising the steps of:
providing fibers,
providing the binder,
providing an elasticizing additive,
applying the binder and the elasticizing additive,
forming the fiber cake from the fibers provided with binder and elasticizing agent,
pressing the fiber cake in a press while curing the binder to manufacture a fiberboard, wherein
   15% to 35% by weight of melamine resin, phenolic resin, mixtures and mixed condensates thereof and/or guanamine resin and 5% to 20% by weight of urea resin as binders and 0.1% to 7% by weight of the elasticizing additive, in each case based on the total weight of the fiberboard (atro), are used.

Urea resin is cheaper than melamine resin. Surprisingly, it turned out that the binder for the water-resistant fiberboard can be supplemented with urea resin. Urea resin can be hydrolyzed, particularly by hot water, and therefore appeared unsuitable for the manufacturing of water-resistant fiberboard. In this respect, the suitability of urea resin for the manufacturing of water-resistant fiberboards was unexpected for experts. The use of urea resin leads to cheaper fiberboards.

### DETAILED DESCRIPTION

To manufacture the water-resistant fiberboard according to the invention, fibers are first provided. Organic or inorganic fibers can be used. Natural fibers, e.g. lignocellulosic fibers, cotton or linen fibers or synthetic fibers such as fibers made of thermoplastic material such as polyethylene or polypropylene, but also of polycarbonate, polyacrylate, polymethacrylate or polyurethane can be used to manufacture the fiberboard according to the invention. Inorganic fibers such as carbon fibers or fibers made of mineral or ceramic raw material or glass fibers are suitable for manufacturing the water-resistant fiberboard, particularly when mixed with other fibers. In particular, mixtures of fibers, especially mixtures of the aforementioned fibers, can be used to manufacture the material according to the invention. Mixtures of fibers make it possible to adjust the properties of the material according to the invention, e.g. the elasticity or the bending properties, the dimensional stability, the strength, but also the manufacturing properties or the processability. If fibers from renewable raw materials are used, in particular lignocellulosic fibers, e.g. fibers from wood, bamboo or annual plants, inexpensive, easy-to-process fibers are available. Natural fibers are preferably used untreated, i.e. the fiber components cellulose and lignin as well as any hemicelluloses are not modified in their properties by chemical processes. The use of hygroscopic fibers is not excluded, in particular if these are at least partially dried before the material according to the invention is manufactured or pressed.

The above-mentioned lignocellulosic fibers include in particular all fibers obtained from plants by chemical or physical processes. Typical examples of physically obtained fibers are softwood fibers, hardwood fibers or bamboo fibers, or fibers from other organic raw materials obtained by mechanical defibration. An example of chemically obtained fibers are cellulose fibers from wood, annual plants or other raw materials, especially renewable raw materials. Wood fibers from mechanical defibration are typically used, whereby the aim is to minimize the loss of lignin and hemicelluloses. Mixtures of fibers can also be used, in particular to adjust the properties of the material (strength properties, weight), but also to use the raw material fiber in a cost-optimized manner. Fibers in the sense of the present invention are also fiber bundles; also included are smaller chips, insofar as their fibers can still be largely coated with binder. According to the invention, it is preferred if the fiber content of the fiberboard is more than 50% by weight of the total weight of the fiberboard. It is further preferred if the proportion of lignocellulosic fibers is more than 50% by weight of the total fiber content.

Insofar as information is provided in connection with this invention on the use of substances, typically binders, elasticizing or hydrophobizing agents, hardeners, colorants or other additives, in particular information in % by weight, this information refers to 100% solids of the respective substance. The actual dosage of the substances can take place in solution, in a mixture or in another way with a solids content of less than 100%. In such a case, the solids content of the added solution or mixture is advantageously also stated or indicated. Examples of usual solids contents are given below, but these are not to be regarded as binding: For binders and also for an elasticizing agent or for an emulsion, a solids content of e.g. 50% by weight to 60% by weight can be assumed; for hardeners, a solids content of e.g. 15% by weight is usual; a colorant can have a solids content of e.g. 24% by weight. In particular with reference to fibers or fiber-containing products such as fiberboards, the term “atro” is used in connection with the invention, which refers to absolutely dry fibers or fiber-containing products. Fibers or fiber-containing products or water-containing products are referred to as “atro” if they have been dried at 105° C. to constant weight.

Binding agents are provided for the manufacturing of water-resistant fiberboard. Melamine resin, phenolic resin, mixtures thereof and mixed condensates or guanamine resin on the one hand and urea resin on the other hand are used. The binder used according to the invention preferably comprises melamine resin. Melamine resin, typically melamine-formaldehyde resin, is used in aqueous solution, wherein the solids content of the melamine resin is preferably at least 45% by weight relative to the aqueous solution, advantageously the solids content is above 50% by weight. The upper limit of the solids content is determined by the solubility and possibly processability of the melamine resin, e.g. in spray nozzles. Alternatively, melamine resin can also be used as a solid, in particular in the form of powder or granules. Melamine resin is preferred as a binder because it proves to be non-swelling and non-hygroscopic as well as resistant to hydrolysis. Phenolic resin can be used as an alternative to melamine resin or in a mixture with melamine resin. Although phenolic resin is water-resistant, it is dark in color and its alkali content makes it slightly hygroscopic, which may be disadvantageous when used in a water-resistant fiberboard. Suitable resins include guanamine resin, melamine-formaldehyde resin, melamine-urea-formaldehyde resin (MUF resin), but also melamine-urea-phenol-formaldehyde resin (MUPF). The individual resins mentioned above, in particular melamine resin, urea resin and phenolic resin, can be used both in a mixture with each other and as mixed condensates. A suitable guanamine resin, e.g. with methyl-methylol groups, is disclosed, for example, in EP 0 011 049 A1.

According to the invention, melamine resin and/or phenolic resin or guanamine resin are used in combination with urea resin. In the context of the present invention, in combination means that a mixture of two or more binders is applied to the fiber simultaneously or at a time interval from one another, e.g. as MF resin (melamine-formaldehyde resin) in mixture with urea resin. Alternatively, mixed condensates such as MUF resin or MUPF resin can be used. A combination of binders is used one after the other, e.g. because they cannot be used in a mixture or because separate application of different binders has an advantageous effect. It is preferred if the binder predominantly contains melamine resin.

According to the invention, the proportion of melamine resin in the binder is 15% to 35% by weight relative to the total weight of the fiberboard (atro), in particular 20% to 30% by weight, advantageously 20% to 25% by weight, particularly preferably 15% to 25% by weight. The melamine resin can be replaced in whole or in part by phenolic resin. The proportion of urea resin according to the invention is 5 wt. % to 20 wt. %, advantageously 5 to 18 wt. %, preferably 10 wt. % to 18 wt. %, particularly preferably 10 wt. % to 15 wt. %, in each case based on the total weight of the fiberboard (atro). The high proportion of urea resin in a water-resistant fiberboard is exceptional. Since urea resin is an inexpensive binder, the use of urea resin helps to significantly reduce the cost of the fiberboard according to the invention.

The total amount of binder used to manufacture the water-resistant fiberboard is preferably up to 48% by weight, particularly preferably up to 45% by weight, advantageously up to 43% by weight, particularly advantageously 20% to 40% by weight, in each case based on the total weight of the fiberboard (atro). The total amount of binder used to manufacture the water-resistant fiberboard can preferably be, for example, a maximum of 40% by weight, advantageously a maximum of 35% by weight, particularly advantageously a maximum of 30% by weight, while the minimum amount used is advantageously 25% by weight based on the total weight of the fiberboard (atro). The reduction in the total amount of binder used compared to known water-resistant fiberboards also helps to reduce the cost of manufacturing the water-resistant fiberboard. It seems unusual that it is possible to reduce the amount of binder used in the manufacture of the water-resistant fiberboard. It is all the more surprising that a non-swelling or low-swelling, water-resistant fiberboard can be manufactured with this reduced use of binder. If the total amount of binder used is related to the amounts in which melamine resin and/or phenolic resin on the one hand and urea resin on the other hand are used, it becomes clear that the respective amounts of melamine resin or phenolic resin on the one hand and urea resin on the other hand can be varied within a wide range. This provides flexibility in the manufacture of the fiberboard according to the invention and enables cost savings over a wide range, in particular due to the use of inexpensive urea resin.

Advantageously, melamine resin or phenolic resin on the one hand and urea resin on the other hand are used in a ratio of 3.5:1 to 1:1, advantageously between 3:1 and 1:1, in particular of 2.5:1, preferably of 2.5-1.5:1. Within the aforementioned limits, the ratio between melamine resin or phenolic resin on the one hand and urea resin on the other can be adjusted continuously. Mixtures of melamine or phenolic resin on the one hand and urea resin on the other, which lie outside this mixing range, enable the manufacturing of a water-resistant fiberboard, they only utilize the advantages of the invention to a lesser extent.

Advantageously, the use of thermoplastic binders is avoided or excluded, in particular the use of thermoplastic binders of more than 7% by weight is avoided or excluded. The fiberboard according to the invention is preferably free of halogens (e.g. fluorine, chlorine), but also of terephthalates.

According to an advantageous embodiment, the elastic properties of the board-shaped material can be modified, in particular improved, by adding an elastomer or thermoplastic used as an elasticizing additive, e.g. by adding polyvinyl acetate (PVAc) or ethyl vinyl acetate, but also a modified isocyanate compound. Acrylate or styrene acrylate are preferably used for elastifying the water-resistant fiberboard according to the invention, in particular in the form of a liquid additive such as e.g. a dispersion or emulsion, because they are water-resistant. Preferably, acrylate and styrene acrylate with a glass transition temperature of TG less than 0° C. are used. However, glycol, e.g. mono- or diethylene glycol, is also suitable for elasticizing the water-resistant fiberboard, as well as caprolactam, longer-chain diols or triols, e.g. glycerol, and polyols, sugars, sugar alcohols or guanamine compounds are also suitable as elasticizing additives. The above-mentioned elasticizing additives can each be used on their own, but also in a mixture of two or more of the above-mentioned components. The addition of elastomers or thermoplastics reduces the brittleness of the water-resistant fiberboard and improves its elastic properties, e.g. the modulus of elasticity. In addition, the addition of elasticizing additives improves the flatness of the water-resistant fiberboard according to the invention. The elasticizing additive is used as 100 wt.-% solids calculated proportionally to the total amount of the water-resistant fiberboard (atro) in an amount of 0.1 wt.-% to 7 wt.-%, preferably from 1 wt.-% to 5 wt.-%, advantageously 2 wt.-% to 4 wt.-%.

The elasticizing additives are, for example, added to the binder, e.g. melamine resin, before application to the fibers and are applied to the fibers together with the binder. Alternatively, the elasticizing agent is advantageously applied to the fibers before or, more preferably, after the binder, e.g. at the end of the blow-line in the dryer tube.

According to a particularly advantageous embodiment of the invention, the elasticizing additive is added during the manufacturing of the binder and condensed into the binder. This procedure ensures a high effectiveness of the elasticizing agent.

According to an advantageous embodiment of the invention, a hardener is added to the binder, which accelerates the hardening of the binder, usually a chemical reaction such as a condensation reaction or an addition reaction. A typical example of a hardener is ammonium sulphate. The addition of the hardener optimizes the hardening of the binder in the press. The hardener does not become part of the binder, as it only triggers a chemical reaction as a catalyst, but does not become part of the resulting polymer. The hardener is used in an amount of 0.1% to 2% by weight, preferably up to 1% by weight, based on the total amount of water-resistant fiberboard (atro) and is preferably applied after the binder has been applied, for example at the end of the blow-line in the dryer tube.

The use of a hydrophobizing agent for the manufacturing of the water-resistant fiberboard according to the invention proves to be further advantageous. For example, paraffin or wax can be used, which, usually as an emulsion, are typically used in amounts of up to 4% by weight based on the weight of the board-shaped material, mostly in amounts of up to 2% by weight, often in an amount of 0.1% by weight to 1.5% by weight, in each case based on the total amount of the water-resistant fiberboard (atro). The hydrophobizing agent is typically used in liquid form, e.g. as an emulsion or dispersion. Alternatively, hot paraffin can be used. It can be used before or after the binder or together with the binder. The use of a hydrophobizing agent also helps to reduce the tendency of the board-shaped material to swell.

In order to ensure in the use of the water-resistant fiberboard that the water-resistant fiberboard according to the invention can be perfectly identified, it may prove advantageous to use colorant for coloring the fiberboard according to the invention. For example, 0.01% by weight to 2% by weight, advantageously 0.05% by weight to 1.5% by weight, in particular 0.1% by weight to 1% by weight of colorant based on the total amount of the water-resistant fiberboard (atro) can be used for this purpose.

Optionally, the water-resistant fiberboard comprises aggregates. As a possible aggregate, fillers can help to optimize the weight of the board-shaped material, usually to minimize it, but in some cases also to increase it, or they can help to further improve the matrix structure of binder and fibers. An aggregate or a combination of aggregates can alternatively or additionally serve to optimize certain properties of the boards, e.g. electrical or thermal conductivity, insulating properties or strength properties. An aggregate generally replaces fibers in the fiberboard according to the invention. Since the water-resistant fiberboard should exhibit minimal swelling in the presence of water, in particular minimized thickness swelling, non-hygroscopic or non-swelling aggregates or fillers as well as aggregates or fillers that are resistant to hydrolysis are preferred. Such aggregates or fillers can be mineral particles, but also ceramic, synthetic or particles made of glass or metal. For example, calcium carbonate (CaCO3) and/or barite (BaSO4) can be used as fillers, particles of metal can be used to improve thermal and/or electrical conductivity or expanded plastic particles can be used to reduce the weight. The size of the particles is preferably not larger than one millimeter, preferably between 10 μm and 800 μm. The particles can have any shape, e.g. granular or powdery, but also filamentary. Mixtures of different particles can also be used, e.g. mixtures of different materials, shapes or sizes. Up to 30% by weight of aggregate based on the total weight of the water-resistant fiberboard (atro) is used, particularly preferably up to 20% by weight, advantageously up to 15% by weight. The lower limit of the quantity used results from the detectability of an aggregate or filler. The aggregate or filler can be applied to the fibers before or after the binder is applied, preferably by spraying or scattering.

The pressing conditions for the water-resistant fiberboard, in particular pressure and temperature, are essentially the same as those for known wood-based materials. Pressure and temperature for the manufacturing of the fiberboard according to the invention are, for example, in the range of conventional HDF boards (high-density fiberboard). However, the pressing time can be significantly less than the pressing time for a known, non-water-resistant HDF board. The material according to the invention can be excellently manufactured in presses such as those used for the manufacturing of wood-based materials. In particular, continuous or discontinuous hot presses, e.g. continuous double belt presses with rotating, heated metal belts or presses working batchwise with press plates. This allows board formats to be manufactured which—unlike WPC—are not limited to the manufacturing of narrow plank formats with a width of up to approx. 100 cm. Instead, conventional board formats can be provided, as is usual for wood-based boards. The water-resistant fiberboard is preferably not extruded.

The fiber cake is usually manufactured by scattering, as is usual with wood-based materials. The fibers, which are preferably provided with the entire amount of binder and preferably dried, are scattered on a carrier, usually on a conveyor belt, usually in a homogeneous layer, but alternatively also in several layers, whereby the layers can have a different composition in terms of fibers, binder or additives. The scattered fiber cake is first passed through a pre-press on the carrier and then pressed in a press.

Any press that applies sufficient pressure and temperature is suitable, both a discontinuous plate press, in which the fiberboard is pressed between two metal sheets, and in particular a continuous press, in which the water-resistant fiberboard is pressed between two circulating metal belts. Preferably, hot presses are used whose press plates or revolving metal belts are heated to a predetermined temperature. Suitable pressing temperatures can be selected from 110° C. to 250° C., preferably from 110° C. to 180° C., preferably from 140° C. to 160° C. (temperature of the press plate or press belt). The thinner the board, the lower the pressing temperature can be selected. Alternatively, the pressing speed can be increased, i.e. the pressing time can be shortened. Suitable pressing pressures are, for example, in the range of 0.3 N/mm² to 5.5 N/mm², in particular 1 N/mm² to 3 N/mm². The pressing time is advantageously 6 seconds/mm board thickness (hereinafter: s/mm) to 60 s/mm, usually 10 s/mm to 30 s/mm, preferably 20 s/mm to 25 s/mm. In order to minimize the pressing time, the temperature can be increased within the aforementioned range. In continuous presses, the feed speed of the circulating metal belts between which the water-resistant fiberboard is manufactured by pressing is usually between 250 mm/second and 400 mm/second, preferably between 300 mm/second and 350 mm/second, depending on the length of the press.

The actual pressing process can be preceded by a pre-press for compacting the fiber cake. Optionally, a device for cooling the fiberboard can be installed downstream of the press, in particular a device for cooling under a predetermined pressing pressure, which can be lower than the pressing pressure during the pressing of the material. A cooling star turner is also often used to cool the boards. Cooling prevents deformation of the board.

The invention also comprises a water-resistant fiberboard comprising fibers and binders, wherein the fiberboard comprises 15 wt. % to 35 wt. % of melamine resin, phenolic resin, mixtures and mixed condensates thereof or guanamine resin and 5 wt. % to 20 wt. % of urea resin, each based on the total weight of the fiberboard (atro). The advantages of the composition of this water-resistant fiberboard have already been explained above in connection with the process according to the invention. All the components of the water-resistant fiberboard explained above in connection with the method can be a component of the water-resistant fiberboard according to the invention, in particular in the proportions mentioned therein. Individual features described in this application for the method or the fiberboard can be combined freely and, as far as technically possible, independently of one another.

The water-resistant fiberboard according to the invention is characterized by the fact that it does not exhibit any significant thickness swelling under the influence of moisture, namely water. A thickness swelling which, relative to the original board thickness, is less than 3%, preferably less than 2%, is regarded as non-significant in the sense of the invention. A fiberboard optimized for minimum thickness swelling and considered to be water-resistant according to the invention has a thickness swelling according to DIN EN 317 or, as a coated fiberboard, an edge swelling according to DIN 13329 of only 0.5% to 1%. It should be noted that the fiberboard according to the invention is uncoated, so that the data given in this application is tested in accordance with DIN EN 317.

The water-resistant fiberboard according to the invention is thus low-swelling or, if a maximum thickness swelling of up to 1% relative to the original board thickness is achieved, is non-swelling and dimensionally stable. This means, for example, that an inexpensive, board-shaped, essentially non-swelling, dimensionally stable material that is not limited to narrow formats and that preferably maximizes the use of renewable raw materials can now be manufactured on known devices for the manufacturing of wood-based boards.

The water-resistant fiberboard according to the invention has good strength properties, in particular a high transverse tensile strength, which is at least 2.5 N/mm², preferably up to 3 N/mm², in particular up to 4 N/mm². The fiberboard according to the invention has a high compressive strength. Due to the good strength properties fewer fasteners, e.g. screws, need to be used to fasten a water-resistant fiberboard according to the invention because the individual fastener has a better hold in the board. The higher transverse tensile strength also allows more intensive processing of a fiberboard according to the invention, e.g. the milling of complex profiles in the narrow surfaces. For example, a complex profile can be worked into the narrow surface of a board that is only 4.3 mm thick, which aligns or connects two interlocking boards both vertically and horizontally. The high compressive strength allows the water-resistant fiberboard to withstand high point loads, making it suitable for vehicle loading floors or as a floor for storage areas, for example. The high flexural strength of the water-resistant fiberboard allows it to be used as a structural element, e.g. for wall stiffening.

The density of the water-resistant fiberboard according to the invention is preferably between 1,000 kg/m³ and 1,800 kg/m³, in particular between 1,000 kg/m³ and 1,600 kg/m³, advantageously between 1,000 kg/m³ and 1,300 kg/m³, particularly advantageously between 1,000 kg/m³ and 1,200 kg/m³. Due to the high amount of binder used, the fiberboard according to the invention has a higher weight than, for example, a wood-based material, e.g. an HDF board, which has a lower proportion of binder.

The fiberboard according to the invention generally has two main surfaces, which are also referred to below as the top and bottom surfaces. The narrow surfaces or edges of the fiberboard are arranged between the top and bottom surfaces. The thickness of the finished fiberboard can range from 0.8 mm to 50 mm, typically between 1 mm and 25 mm, mostly between 3 mm and 20 mm. A typical application may require a thickness of the water-resistant fiberboard of 4 mm to 10 mm, in particular between 4 mm and 7 mm. The fiberboard according to the invention can have flat main surfaces; however, the upper and/or lower surfaces can also be embossed or milled or otherwise processed, so that a variable thickness of the fiberboard is obtained in relation to the surface area of the material, e.g. in the case of furniture fronts into which a relief is incorporated. The water-resistant fiberboard preferably has a composition that is essentially homogeneous across the thickness.

The top and bottom surfaces, as well as the narrow surfaces, can be processed using standard tools. For example, they can be sawn, cut or milled. The maximum length and width of the fiberboard according to the invention is limited solely by the available presses used to manufacture the material. Smaller dimensions can be manufactured by cutting or dividing the finished water-resistant fiberboard. Typical dimensions of the fiberboard can be 5600 mm (length)×2070 mm (width) or 5600 mm×2800 mm after manufacturing in the press, 1380 mm×195 mm, after splitting into floor, wall or ceiling panels or 3048 mm×2800 mm. The latter format is particularly suitable for use as a construction board in buildings, because the width of the board has storey height.

The water-resistant fiberboard according to the invention can be used in a variety of ways, in particular for structural purposes in interior and exterior construction or in exterior applications. It can be used, for example, as a floor, ceiling and/or wall covering, for the manufacture of interior fittings or furniture, in particular also for the interior fittings of vehicles, such as vehicle cabins or floor panels, but also outdoors, both as a facade panel or cladding, for example as a curtain wall, as balcony cladding, as an exterior window sill or roof covering, but also for outdoor furniture or for the manufacture of signs. The water-resistant fiberboard according to the invention is suitable as a wall, ceiling and/or floor covering in damp or wet rooms, but also for equipping them with partition walls, benches or furniture.

The water-resistant fiberboard according to the invention can be coated, colored, painted or otherwise decoratively designed. In particular, surface coatings, such as those known from the field of wood-based materials, can be applied to the surface of the material according to the invention. Furthermore, the board-shaped material according to the invention can be used as a component of a sandwich board, i.e. the material according to the invention can be combined with the same or other foil or board-shaped materials, in particular wood-based boards, but also plastic boards or foils, to form a sandwich board. A coating can further improve the swelling and shrinkage properties of the water-resistant fiberboard.

The features of the invention described above can be freely combined with each other.

Details of the invention are explained with reference to examples of embodiments.

### Embodiment Example 1

To manufacture a fiberboard of 8 mm thickness, alternatively of a thickness between 0.8 mm and 50 mm, lignocellulosic fibers manufactured by mechanical or chemical-mechanical processes, alternatively synthetic fibers, e.g. made of plastic, inorganic fibers or chemically manufactured fibers made of lignocellulosic material are provided. Mixtures of different fibers can also be used. In the present embodiment example, 50% by weight of fibers are provided.

A binder is also provided, as shown in Table 1. For the present embodiment example, 29% by weight of melamine resin and 16% by weight of urea resin are used, in each case based on the total weight of the water-resistant fiberboard. These quantities used are within a range according to the invention of 15 wt. % to 35 wt. % melamine or phenolic resin and 5 wt. % to 20 wt. % urea resin. A total of 45% by weight of binder is used in relation to the total weight of the fiberboard (atro). Proportionally, melamine resin, which can be replaced in whole or in part by phenolic resin, and urea resin are used in a ratio of 1.9:1 based on the weight of the respective components used, whereby the ratio can be adjusted in a preferred range of 3.5:1 to 1:1. In this embodiment, the melamine resin is applied as a solution with a solids content of 50% by weight; the urea resin is also applied as a solution, but with a solids content of 60% by weight. The two components of the binder are sprayed onto the fibers at the same time; alternatively, they can be applied one after the other.

An elasticizing agent, in this case styrene acrylate, is sprayed onto the fibers as a solution in a proportion of 2.5% by weight based on 100% by weight of solid material. The elasticizing agent can be used in an amount of 0.1% to 7% by weight based on the total weight of the fiberboard (atro). It has the effect of reducing the brittleness of the water-resistant fiberboard. As a result, the water-resistant fiberboard remains flat and brittle fracture behavior is avoided.

The binder content of the fiberboard according to the embodiment example is reduced to 45% by weight; even taking into account the elasticizing agent, the binder content is less than 50% by weight, in this case 47.5% by weight. In principle, the binder content can preferably be a maximum of 48% by weight to a minimum of 25% by weight based on atro fiberboard.

Optional components can also be added, such as the components listed in Table 1, which are explained below. Typically, a hardener for the binder is sprayed onto the fibers, in this case ammonium sulfate in a proportion of 0.9% by weight, based on the amount of binder used in each case. The non-swelling properties of the water-resistant fiberboard are supported, in the example embodiment by the addition of 1.5% by weight of wax or oil, which is used here as an emulsion. Finally, the water-resistant fiberboard according to the embodiment example is made visually identifiable by the use of 0.1% by weight colorant, so that it cannot be mixed up with other fiberboards that are not water-resistant during use.

In the present embodiment example, the components described above can be applied to the fibers simultaneously or sequentially, with sequential application being preferred because the dosage of the components can be better controlled. According to the embodiment example, the fibers are then dried to a moisture content of approx. 8% after the components have been applied. Alternatively, the components, in particular the optional components, can also be applied to already dried fibers. According to a further alternative, the hardener, colorant and hydrophobizing agent, for example, can also be applied to the already dried fibers, which have been provided with binder and elasticizing agent, after drying but before scattering to form a fiber cake.

The fibers provided with all components are scattered to form a fiber cake. The fiber cake is pressed into a water-resistant fiberboard in a known, continuously operating double belt press at 180° C. and a pressure of 2.5 N/mm² at a pressing time factor of 15 s/mm. These conditions were selected from a range comprising a pressing temperature of 110° C. to 250° C. and a pressing pressure of 0.3 N/mm² to 5.5 N/mm². The pressing time factor can be selected from a range of 6 s/mm to 60 s/mm. The water-resistant fiberboard manufactured in this way has a thickness of 8 mm and a density of 1113 kg/m³ (atro), see Table 1. The finished water-resistant fiberboard usually has a moisture content of approx. 6%, so that the weight of the fiberboard in ready-to-use condition is approx. 1,180 kg/m³.

TABLE 1
Composition of water-resistant fiberboard (Data in each case 100%
solids or atro, each based on atro water-resistant fiberboard)

| | Absolute weight | Content |
|---|---|---|
| Component | (kg/m³) | (wt-%) |
| Water-resistant fiberboard | 1,113 | 100 |
| fibers | 556 | 50 |
| Melamine resin | 325 | 29 |
| Urea resin | 175 | 16 |
| Ammonium sulphate | 10 | 0.9 |
| Styrene acrylate | 28 | 2.5 |
| Emulsion | 17 | 1.5 |
| Colorant | 2 | 0.1 |

The water-resistant fiberboard manufactured in this way is tested for swelling as an uncoated fiberboard in accordance with DIN EN 317 and for edge swelling in accordance with DIN 13329. The thickness swelling is determined in the center of the sample as a change in mm in relation to the initial thickness of 8 mm in absolute terms and also as a relative change. Edge swelling is determined at one edge of the coated material as a change in mm relative to the initial thickness of 8 mm in absolute terms and also as a relative change (%).

The thickness swelling for the water-resistant fiberboard manufactured according to the above embodiment example is less than 2% relative to the thickness of the fiberboard. It is thus reduced by more than 90% compared to the thickness swelling of a non-water-resistant fiberboard, which is more than 20%. The edge swelling of the water-resistant fiberboard according to the embodiment example is less than 1.5%, whereas the edge swelling of a known, non-water-resistant fiberboard is more than approx. 15%. Here, too, the edge swelling is reduced by approx. 90%. This result is all the more astonishing as the water-resistant fiberboard according to the invention contains urea resin. In the water-resistant fiberboard according to the embodiment example, it is 16% by weight or about one third of the total binder used. Despite this high proportion of urea resin, which is accessible to hydrolysis, the edge swelling and the thickness swelling are reduced by about 90% and more, thus providing a water-resistant fiberboard which can be manufactured more cost-effectively than known water-resistant fiberboards by using a less expensive binder. There is also a significant cost advantage in that the binder content has been reduced to 45%. A further significant cost advantage results from the use of urea resin, which, although it can be hydrolyzed by water, is used here in the manufacturing of a water-resistant fiberboard. Even taking into account the elasticizing agent, the binder content is less than 50% by weight, in this case 47.5% by weight.

Despite this modified composition, the water-resistant fiberboard also has comparable strength properties to the water-resistant fiberboard known from WO 2020/211988 A1. Thus, the inexpensive and water-resistant fiberboard according to the invention can be used in the same way as the known water-resistant fiberboard.

The fiberboard according to the invention can be coated well, whereby the coating usually further reduces the thickness swelling and possibly also the edge swelling.

### Embodiment Example 2

In this example, approx. 99% by weight of binder is used in relation to the proportion of wood fibers. In relation to the total weight of the water-resistant fiberboard, approx. 45% by weight of binder is used. The amount of binder is divided into 33.8% by weight melamine resin and 11.22% by weight urea resin, each based on the total weight of the fiberboard. This means that melamine resin and urea resin are used in a ratio of approx. 3:1. Furthermore, 0.9% by weight of hardener, in this case ammonium sulphate, is also used. For elasticizing the fiberboard, 2.5% by weight of styrene acrylate is used. Furthermore, a wax emulsion is used in a quantity of 1.5% by weight and colorant in a proportion of 0.05% by weight, in each case based on the total weight of the fiberboard.

TABLE 2
Alternative composition of the water-resistant fiberboard
with approx. 99% by weight binder in relation to the
fiber content (Data in each case 100% solids or atro,
each based on atro water-resistant fiberboard)

| | Absolute weight | Content |
|---|---|---|
| Component | (kg/m³) | (wt-%) |
| Water-resistant fiberboard | 1113.00 | 100.00 |
| fibers | 556.91 | 50.03 |
| Melamine resin | 376.27 | 33.80 |
| Urea resin | 124.95 | 11.22 |
| Ammonium sulphate | 10.02 | 0.90 |
| Styrene acrylate | 27.85 | 2.50 |
| Emulsion | 16.71 | 1.50 |
| Colorant | 0.50 | 0.05 |

The table shows the components of the fiberboard in % by weight based on the total weight of the fiberboard. The pressing conditions, the addition or mixing of the individual components and the solids content of the components are the same as in embodiment example 1. The weight also corresponds to the board in embodiment example 1.

The fiberboard manufactured according to the mixture given in Table 2 is inexpensive due to the proportion of urea resin, but is nevertheless water-resistant.

### Embodiment Example 3

In this embodiment example, the binder content is reduced to 70% by weight relative to the proportion of fibers. The ratio of melamine resin to urea resin is set at 3:1, the same as in embodiment example 1; however, only 29.28% by weight of melamine resin and 9.72% by weight of urea resin are used due to the reduced binder content. Accordingly, the use of hardener is also reduced to 0.68% by weight. The use of styrene acrylate, on the other hand, increases slightly to 2.7% by weight, as does the use of the hydrophobizing agent, in this case a wax emulsion, to 1.62% by weight. The use of colorant is limited to 0.4% by weight. Unless otherwise stated, all the above weight specifications refer to the total weight of the fiberboard.

TABLE 3
Alternative composition of the water-resistant fiberboard with 70
wt. % binder in relation to the fiber content (Data in each case
100% solids or atro, each based on atro water-resistant fiberboard)

| | Absolute weight | Content |
|---|---|---|
| Component | (kg/m³) | (wt-%) |
| Water-resistant fiberboard | 1113.00 | 100.00 |
| fibers | 620.28 | 55.72 |
| Melamine resin | 325.95 | 29.28 |
| Urea resin | 108.24 | 9.72 |
| Ammonium sulphate | 7.82 | 0.68 |
| Styrene acrylate | 31.03 | 2.70 |
| Emulsion | 18.62 | 1.62 |
| Colorant | 0.43 | 0.04 |

The table shows the components of the fiberboard in % by weight based on the total weight of the fiberboard. The pressing conditions, the addition or mixing of the individual components and the solids content of the components are the same as in embodiment example 1. The weight also corresponds to the board in embodiment example 1.

Despite the reduced proportion of binder and the relatively high proportion of urea resin, the fiberboard manufactured according to the mixture shown in Table 3 is water-resistant and, of course, particularly cost-effective to manufacture.

### Embodiment Example 4

In embodiment 4, the proportion of binder is further reduced to just 60% by weight of the fiber content. At the same time, the proportion of urea resin is increased to 1:1. In relation to the total weight of the water-resistant fiberboard, the proportion of binder is approx. 36% by weight. The proportion of hardener, also in this case ammonium sulphate, is adjusted to 0.71% by weight. The proportion of styrene acrylate, which is used for elasticizing the fiberboard, is increased to 2.95% by weight, as is the proportion of hydrophobizing agent, which is also used here as a wax emulsion in an amount of 1.77% by weight. Colorant is added in a proportion of 0.04% by weight. Unless otherwise stated, all the above weights refer to the total weight of the fiberboard.

TABLE 4
Alternative composition of the water-resistant fiberboard with 60%
binder by weight relative to the fiber content (Data in each case
100% solids or atro, each based on atro water-resistant fiberboard)

| | Absolute weight | Content |
|---|---|---|
| Component | (kg/m³) | (wt-%) |
| Water-resistant fiberboard | 1113.00 | 100.00 |
| fibers | 657.69 | 59.08 |
| Melamine resin | 197.01 | 17.70 |
| Urea resin | 197.61 | 17.75 |
| Ammonium sulphate | 7.89 | 0.71 |
| Styrene acrylate | 32.88 | 2.95 |
| Emulsion | 19.73 | 1.77 |
| Colorant | 0.39 | 0.04 |

The table shows the components of the fiberboard in % by weight based on the total weight of the fiberboard. The pressing conditions, the addition or mixing of the individual components and the solids content of the components are the same as in embodiment example 1. The weight also corresponds to the board in embodiment example 1.

Despite the reduced proportion of binder and the high proportion of urea resin, the fiberboard manufactured according to the mixture shown in Table 4 is water-resistant and of course particularly cost-effective to manufacture.

1. Method for manufacturing a water-resistant fiberboard comprising lignocellulosic fibers and binder, comprising the steps of
providing fibers,
providing the binder,
providing an elasticizing additive
applying the binder and the elasticizing additive,
forming the fiber cake from the fibers provided with binder and elasticizing agent,
pressing the fiber cake in a press while curing the binder to manufacture a fiber cake, wherein
from 15% to 35% by weight of melamine resin, phenolic resin, mixtures and mixed condensates thereof and/or guanamine resin and from 5% to 20% by weight of urea resin as binders and from 0.1% to 7% by weight of the elasticizing additive, in each case based on the total weight of the fiberboard atro, are used.

2. Method according to claim 1, wherein 15% by weight to 30% by weight of melamine resin or phenolic resin based on the total weight of the fiberboard atro, are used.

3. Method according to claim 1, wherein 5% by weight to 18% by weight of urea resin based on the total weight of the fiberboard atro, are used.

4. Method according to claim 1, wherein the use of binder is at least 20% by weight and does not exceed up to 48% by weight based on the total weight of the fiberboard atro.

5. Method according to claim 1, wherein the binder melamine resin or phenolic resin and urea resin are used in a ratio of 3.5:1, to 1:1.

6. Method according to claim 1, wherein 1 wt. % to 5 wt. % of the elasticizing additive based on the total weight of the fiberboard atro, are used.

7. Method according to claim 1, wherein 0.1% by weight to 4% by weight of a hydrophobizing agent is used based on the total weight of the fiberboard atro.

8. Method according to claim 1, wherein 0.1% by weight up to 2% by weight of a hardener is used for the binder based on the total weight of the fiberboard atro.

9. Method according to claim 1, wherein 0.01% by weight to 2% by weight of colorant based on the total weight of the fiberboard atro, is used.

10. A water-resistant fiberboard comprising fibers and binder, wherein the fiberboard comprises 15% by weight to 35% by weight of melamine resin, phenolic resin, mixtures and mixed condensates thereof or guanamine resin and 5% by weight to 20% by weight of urea resin, in each case based on the total weight of the fiberboard atro.

11. Fiberboard according to claim 10, wherein the fiberboard has, based on the total weight of the fiberboard (atro), at least 20% by weight, at most 48% by weight of binder.

12. Fiberboard according to claim 10 or 11, wherein the binder comprises melamine resin or phenolic resin and urea resin in a ratio of 3.5:1 to 1.5:1.

13. A fiberboard according to claim 10, wherein the fiberboard comprises 0.1 wt.-% to 7 wt.-% by weight of an elasticizing additive, the elasticizing additive being selected from the group comprising an elastomer, in particular polyvinyl acetate (PVAc), ethyl vinyl acetate, an acrylate, a styrene acrylate or a polyurethane (PU), a thermoplastic, but also a glycol, in particular a mono- or diethylene glycol, as well as caprolactam, longer-chain diols or triols, in particular glycerol and also polyols, sugars, sugar alcohols or guanamine compounds.

14. Fiberboard according to claim 10, wherein the fiberboard comprises up to 4% by weight of hydrophobing agent, up to 2% by weight of colorant and/or up to 2% by weight of hardener, in each case based on the total weight of the fiberboard atro.

15. Fiberboard according to claim 10, wherein the fiberboard has a coating.

16. Use of the water-resistant fiberboard according to claim 10, wherein the fiberboard is used for facade boards, exterior window sills and roof coverings.

17. Method according to claim 2, wherein 20% by weight to 25% by weight of melamine resin or phenolic resin based on the total weight of the fiberboard atro are used.

18. Method according to claim 3, wherein 10% by weight to 18% by weight of urea resin based on the total weight of the fiberboard atro are used.

19. Method according to claim 4, wherein the use of binder does not exceed 45% by weight.

20. Method according to claim 5, wherein the ratio is 3:1 to 1.5:1.
